(19) United States
(12) Patent Application Publication
(10) Pub. No.: US 2015/0278975 A1
(43) Pub. Date: Oct. 1, 2015

(54) SYSTEM, APPLICATION AND METHOD FOR MANAGING PATIENT CARE COORDINATION

(71) Applicant: Larry D. ALLEN, Colfax, NC (US)

(72) Inventor: Larry D. ALLEN, Colfax, NC (US)

(21) Appl. No.: 14/227,229

(22) Filed: Mar. 27, 2014

(51) Int. Cl. G06Q 50/24; G06F 19/00; G06Q 10/10

(52) U.S. Cl. CPC G06Q 50/24; G06Q 10/10; G06F 19/322

(57) ABSTRACT

A system coordinates patient transitions of care and manages a patient's care from diagnosis to solution no matter how long it takes or how many healthcare providers are involved during the continuum of care. The system brings all of the people interactions into a protected, access-controlled environment that allows a patient's entire continuum of care, inclusive of diagnostic and demographic data, documentation, forms, communication and collaboration, as well as a patient's transition of care, to be coordinated among as many healthcare providers as are needed for as long as needed. The system replaces many of the manual steps currently performed with automated tools, notifications and reminders. The system includes a telehealth module allowing for video connections among provider, patients, staff and the like.

### BACKGROUND OF THE INVENTION

The present invention relates to patient care coordination and, more particularly, to a system, application and method for managing patient care coordination throughout the patient's entire continuum of care and patient transition management.

Coordinating patient care and managing patient transitions of care are expensive and error-prone manual processes that rely mostly on old technology such as phone calls, faxes, verbal messages, and sticky notes. Industry software vendors are focusing on leveraging their own proprietary technology to exchange data more efficiently, but there is no comprehensive care coordination service currently available. Communications, collaboration, and care coordination related to patient care and patient transitions are not effectively addressed.

As mentioned above, the current solutions are a mostly manual process that is costly, time-consuming, and error-prone. The primary healthcare provider (normally a primary care physician or PCP) cannot easily keep informed about the care his/her/its patient is being provided by other providers; e.g., from a referral. A referral is treated as a discrete event. When multiple providers are involved, there is little or no coordination among them. This can result in redundant information preparation, duplicate procedures, PCP and other involved providers being left out of the loop, lack of provider awareness of patients who do not show for referred care (which can result in provider liability), and a less than optimal care coordination experience for the patient.

As can be seen, there is a need for a system managing patient care coordination throughout the patient's entire continuum of care and patient transition management.

### SUMMARY OF THE INVENTION

In one aspect of the present invention, a computer-implemented method, written as a programmable code, stored on a computer readable medium, and adapted to manage referral of patients, the method comprises signing into a computer system as a sending provider agent, the computer system having a plurality of provider agents registered therewith; searching a master patient index database for a patient to be referred; selecting a receiving provider agent to refer the patient; electronically sending, through the computer system, information on the patient to be referred; receiving, by the receiving provider agent, through the computer system, the information on the patient to be referred; and entering, by the receiving provider agent, a final report concerning the patient, the final report viewable by the sending provider agent.

In another aspect of the present invention, a system for managing patient care and referrals comprises a computer system including a database of providers and master patient information records; a referral system application, written as a programmable code, stored on a computer readable medium, and adapted to manage referral of patients, the application comprising code segments to allow users to perform the following steps: signing into the computer system as a sending provider agent; searching the master patient index record database for a patient to be referred; selecting a receiving provider agent to refer the patient; electronically sending, through the computer system, information on the patient to be referred; receiving, by the receiving provider agent, through the computer system, the information on the patient to be referred; and entering, by the receiving provider agent, a final report concerning the patient, the final report viewable by the sending provider agent.

These and other features, aspects and advantages of the present invention will become better understood with reference to the following drawings, description and claims.

### BRIEF DESCRIPTION OF THE DRAWINGS

FIG. 1 is a flow chart describing steps involved when a user requests a new MedTegra Center according to an exemplary embodiment of the present invention;

FIG. 2 is a flow chart describing steps involved in creating a provider profile after the creation of the new MedTegra Center in FIG. 1, according to an exemplary embodiment of the present invention;

FIG. 3 is a flow chart describing steps involved for each provider to define their profile according to an exemplary embodiment of the present invention;

FIG. 4 is a flow chart describing steps involved in the setup and operation of a patient referral system according to an exemplary embodiment of the present invention;

FIG. 5 is a continuation of the flow chart of FIG. 4;

FIG. 6 is a continuation of the flow chart of FIG. 5;

FIG. 7 is a flow chart describing a patient connections home page with exemplary actions for patients that access the system;

FIG. 8 is a flow chart describing exemplary steps for a patient initiated video (referred to as a TegraVideo) telehealth conference;

FIG. 9 is a continuation of the flow chart of FIG. 8;

FIG. 10 is a flow chart describing exemplary steps for a provider initiated video telehealth conference;

FIG. 11 is a continuation of the flow chart of FIG. 10;

FIG. 12 is a flow chart describing exemplary steps for TegraVideos for providers within a ReferralSafe (RS); and

FIG. 13 is a flow chart describing exemplary steps for TegraVideo for general use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system to coordinate patient transitions of care and to manage a patient's care from diagnosis to solution no matter how long it takes or how many healthcare providers are involved during the continuum of care. The system of the present invention brings all of the people interactions into a protected, access-controlled environment that allows a patient's entire continuum of care, inclusive of diagnostic and demographic data, documentation, forms, communication and collaboration, as well as a patient's transition of care, to be coordinated among as many healthcare providers as are needed for as long as needed. The system replaces many of the manual steps currently performed with automated tools, notifications and reminders. The system of the present invention is agnostic to and supports interoperability with other healthcare record systems, including paper-based systems. The capabilities of the system of the present invention can even be integrated into other products and services.

Referring now to the Figures, the core functionality of the system of the present invention, not including secondary administrative tools, reports, libraries, and the like, includes four key functions:

(1) MedTegra Care Coordination Center Creation (MedTegra Center Creation);

(2) MedTegra Care Coordination Center Configuration (MedTegra Center Configuration);

(3) Provider Set Setup; and

(4) ReferralSafe and Patient Referral Creation and Operation. Each of these functions are described in greater detail below.

The following terms and abbreviations may be used throughout the document. “Favorites” refers to a subset of the MedTegra global Provider Agent directory, entries selected into a Favorites list to facilitate selection of the RPA for a patient referral. “MC” refers to the MedTegra Patient Care Coordination Center, also called MedTegra Care Coordination Center, also called MedTegra Center. “MC owner” refers to the person financially and administratively responsible for his/her organization's MC; an “owner” in the sense of owning the right to use that MC for its intended purpose. “MedTegra global Provider Agent directory” refers to a directory of all Provider Agents for all MCs. “MPI” refers to a Master Patient Index, a database of all patient records within the MedTegra system. “Provider” refers to a person or organization that is authorized to provide patient care and to send or receive patient referrals. “Provider Agent” (PA) refers to a provider at a specific organization location and, optionally, at a specific department; called Provider in public use; it can be represented by the provider, delegate, or staff that comprises the PA (that is, when saying “The PA contacted . . . ” it can be the provider, delegate, or staff who did the contacting. “Sending Provider Agent” (SPA) refers to the Referring Provider Agent or the one who refers a patient to a receiving Provider Agent. “Receiving Provider Agent” (RPA) refers to the one to whom a patient is referred. “PR” refers to a Patient Referral, included and documented within a RS. A RS includes one or more Patient Referrals. “RS” refers to the ReferralSafe system and process described below. The term “Provider Set” (PS) may be substituted for the term “Provider Agent” (PA). This includes substituting the terms “Receiving Provider Set” (RPS) and “Sending Provider Set” (SPS) for “Receiving Provider Agent” (RPA) and “Sending Provider Agent” (SPA), respectively.

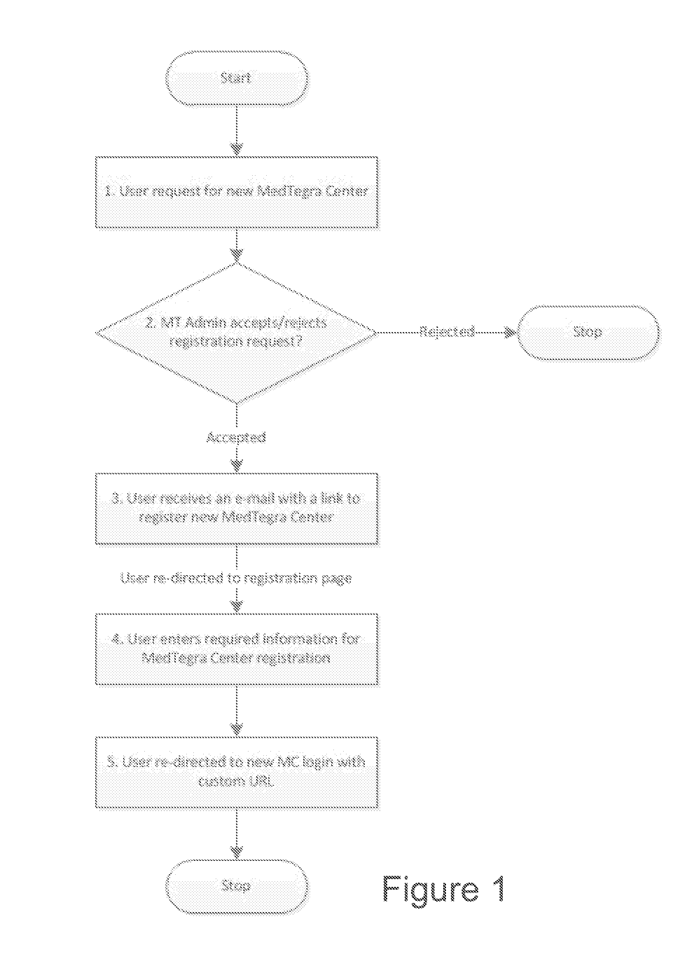

Referring now to FIG. 1, a process for MedTegra Care Coordination Center Creation (MedTegra Center Creation) is described. A person in a position of authority can submit a request for the creation of a MedTegra Center for his/her organization. MedTegra reviews the request, verifies the validity of the organization, verifies the person who has authority to “own” the MC, that person's contact information, and the organization's desire to have a MC. If the request is accepted, an invitation is code is automatically assigned and recorded in an invitation record and an invitation email is sent to the prospective MC owner to create a MC. Optionally, the invitation code can be communicated by other means and the user can go directly to the registration page and enter the invitation code to create a MC. Via a link in the invitation email or by going directly to the registration page and entering the invitation code, the user completes and submits a form and a MC is created for that organization. The user is signed in to the new MC.

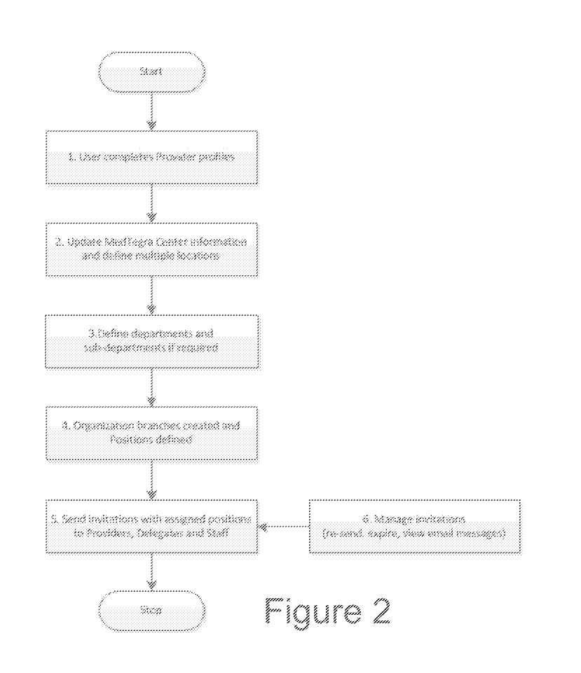

Referring now to FIG. 2, steps in MedTegra Care Coordination Center Configuration (MedTegra Center Configuration) are shown. First, the MC owner signs in to the organization's MC and completes the steps required to configure the MC for use including the creation of Provider profiles. Profiles for each organization location are then created. Departments and sub-departments are optionally defined. User positions and organization branches are created as desired. User accounts are created for members of the organization who are given access to the MC and a position(s) with its associated permissions are assigned to each user. An invitation is prepared and a copy emailed to each user to register in the MC. Via a link in the invitation email or by going directly to the registration page and entering the invitation code, the user completes and submits a form and registers a user account in the MC. Applicable users are assigned as providers, delegates, and staff. As required, pending invitations are managed.

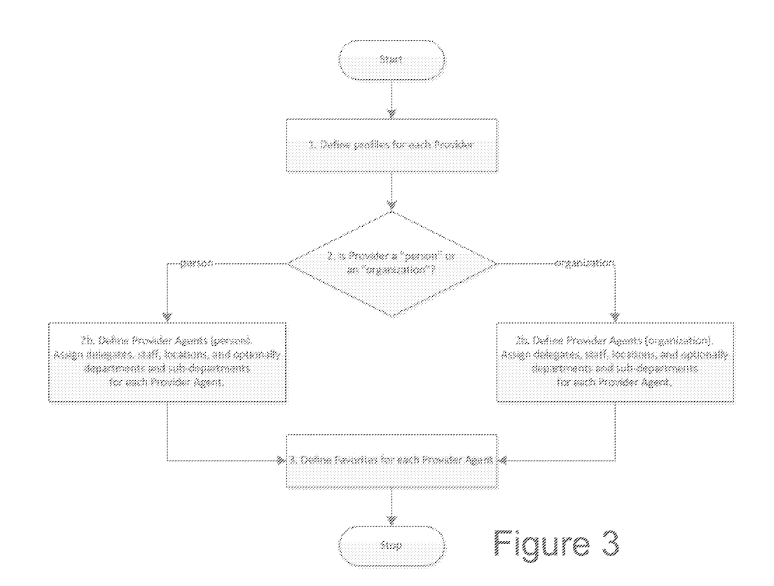

Referring to FIG. 3, steps for Provider Agent Setup are described. Provider Agents are created for each provider for each organization location used by each provider. The resulting provider agent records and applicable related information comprise a directory of provider agents for that organization and spanning all MCs. This directory is used for visibility of provider agents and as a resource for selecting a receiving provider for a patient referral.

First, if not yet completed, Provider (organization and person) profiles are defined. Provider Agent records are then created for each desired combination of provider, location, and optionally department and sub-department. For example, a physician who works two days at one office and two days at another office would have two Provider Agent records, each one serving as a specific receiving or sending point for a patient referral. Similarly, as another example, patient referrals can be sent to a practice without specifying a particular physician, so each location and/or department of the organization can be designated as a Provider Agent. Delegates and staff are assigned to each Provider Agent. Delegates can act as proxy to the Provider, receiving and acting upon notifications, alerts, messages, etc. as directed by the Provider. Staff are assigned to assist the Provider with the workflow.

Favorites can then be selected for each Provider Agent. The Favorites list serves as a list from which a Provider Agent is selected as the receiving Provider Agent for a given patient Referral.

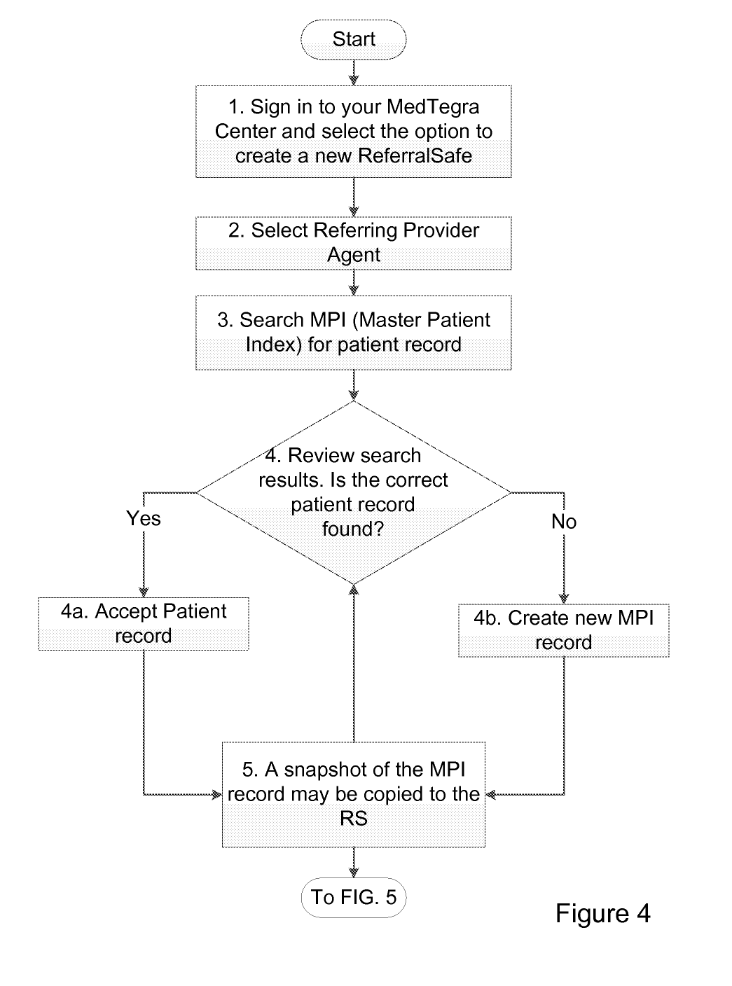

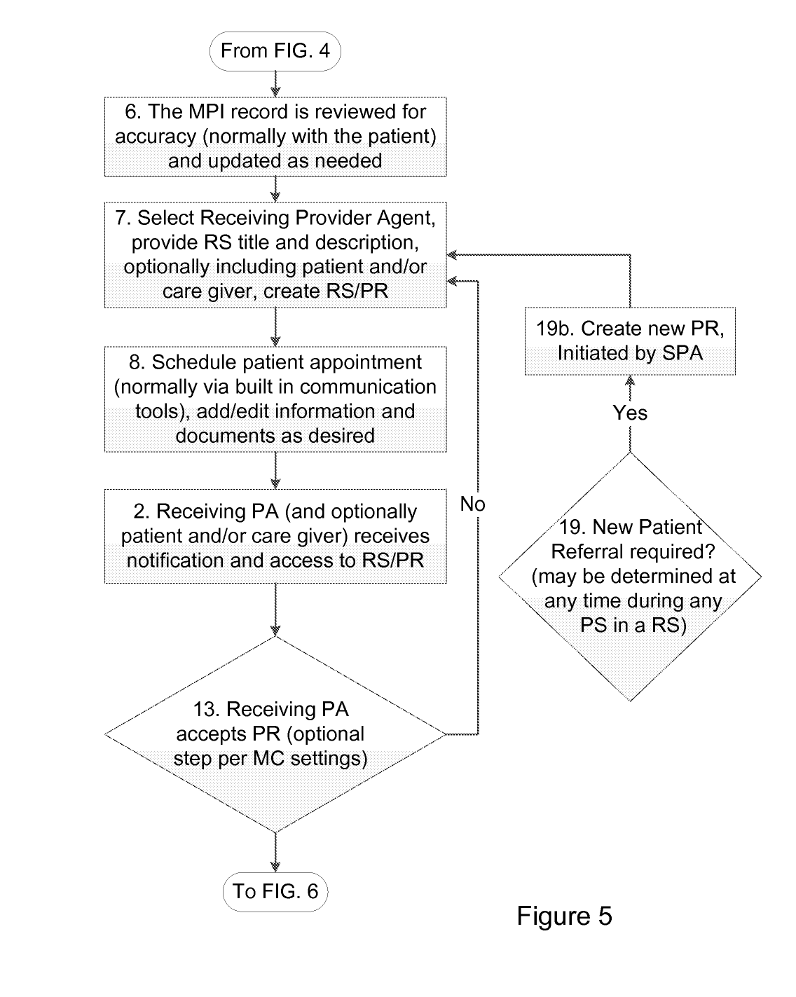

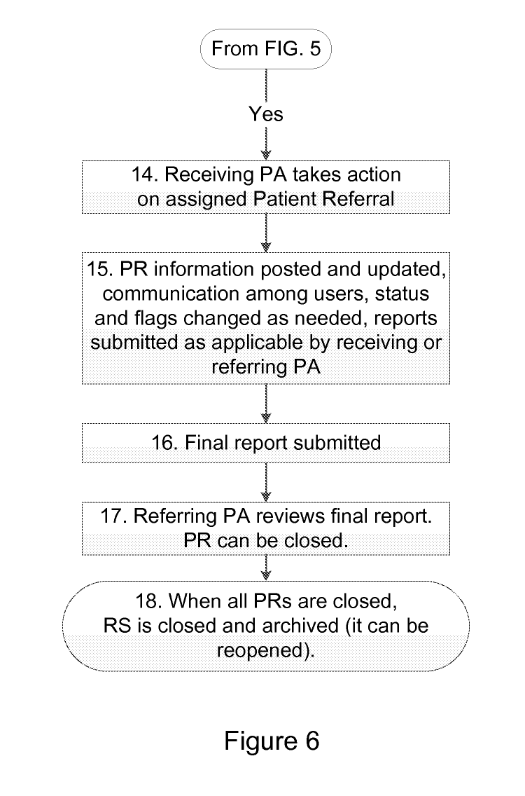

Referring now to FIGS. 4 through 6, the setup and operation of ReferralSafe is described. With the foregoing configuration and setup steps having progressed sufficiently (as described above with reference to FIGS. 1 through 3), patient referrals (sending and receiving) can then be processed. The SPA, or designated helper (delegate or staff) at the request of the SPA, initiates a ReferralSafe and its initial patient referral. There is no fixed order in the steps to send a patient referral, but the steps include the following, where the step numbers listed are not meant to define any particular order, but instead, to simply coordinate the step numbers with those labeled in the drawings:

In step (1), the user signs in to his/her MedTegra Center. A new ReferralSafe is opened and its first Patient Referral created. In step (2), the applicable SPA (a delegate may be assigned to more than one SPA) is selected. Step (3) includes searching for the MPI for the applicable MPI record. In step (4), the search results can be reviewed. The review can include opening the candidate record to verify it is for the correct patient and selecting the desired result for the patient referral. If there is no MPI record for the patient, a new MPI record can be created. In step (5), a snapshot copy of the selected MPI record is added to the RS and, in step (6), the MPI record is optionally reviewed for accuracy by the patient (or the equivalent via interview or other means with the MC staff) and updated as needed (which also updates the master MPI record, the changes to both the snapshot and master records audit tracked).

In step (7), a RPA is selected from the PA directory or from the SPA's Favorites. The RPA may be a physician or any individual authorized to receive patient referrals or it may be the practice or organization without specifying a particular individual provider. It may be a clinic or a lab or other facility. In step (8), the RPA is optionally contacted by the SPA (via MedTegra communication functions or by conventional means) to schedule the first appointment for the patient with the RPA and to record the appointment in the newly created PA within the RS. If not set, it is calculated based upon default settings in the MC preferences. This date can be edited at any time. This date is used to send a reminder to the RPA to confirm that the patient showed for the appointment and to send a notification of this (or lack of response) to the SPA. An estimated Final Report Due Date is set. If not set, it is calculated based upon default settings in the MC preferences. This date can be edited at any time. This date is used to send a reminder to the RPA and SPA if the report is not posted by the due date. The RPA is assigned a level of access to the RS. Normal access includes the entire RS and all communications therein except as otherwise kept private; e.g., private messages. Limited access can, for example, limit an RPA to the assigned PR within the RS plus data specific to the RS that is not part of a PR therein. MedTegra controls user access such that each user is able to easily access all ReferralSafes and other information that pertains directly to them while not even being aware of anything they are not authorized to access.

In step (9), information and documentation are added to the PR including but not limited to clinical data, diagnoses, and SPA notes.

In step (10), insurance coverage information is normally received from the patient's MPI record, but it can be edited or added here. Insurance authorization is optionally obtained and recorded in the RS for a given PR.

In step (11), the PR is activated and notifications and tasks sent to the RPA. In step (12), the RPA signs in to MedTegra, sees the pending RS/PR and associated notifications and tasks, reviews the PR. In step (13), the RPA accepts the patient referral. Otherwise the patient referral is declined. The SPA is informed of the decision. If the PR is declined, then the SPA repeats the process with a different RPA. In step (14), if the SPA accepts the PR, then the patient is seen at the scheduled time.

In step (15), reports, messages, and/or other information are posted to the PR. The PR status is changed as applicable. All PAs participating in the RS are immediately sent notifications of new content or other changes. Notifications can be marked urgent and impose a higher level of notification alerts.

In step (16), when the RPA submits a final report to the PR, the SPA and others with full access in the RS are notified. In step (17), the SPA for the PA reviews the reports and, when ready, closes the PR. In step (18), when all PRs are closed, the RS is closed and archived.

In step (19), if the SPA or RPA decides to refer the patient to another RPA, a new PR can be opened within the RS and the above process is repeated. As many additional referrals as the patient may require are handled within the RS in the same manner.

As new PAs are added to a RS, they inherit all of the documented files, reports and communications previous providers have entered into the RS which eliminates the need for repetitive collection copying and sending of patient information—a significant time and cost savings for the PCP.

If desired or required by law, the primary care physician or “Medical Home” (set up as a SPA) can be required to authorize additional PRs or can be required to initiate additional PRs.

At any time, the PCP (and all authorized PAs in the RS) can review what has been recorded in the RS, an effective way for a PCP to track the care others provide to his/her patients.

If a patient does not show or if a report is not submitted before a user or system defined due date, the appropriate participants in the PR are reminded via notification and task assignments.

A RPA who no longer has a need to be involved in notifications and tasks from the PR, and has submitted the final report, can set his/her status in the PA to quiet mode and no longer receive notifications.

All actions and changes are tracked in write-only audit records. Connections to the MedTegra service via the Internet are encrypted via https secure connections. MedTegra databases are encrypted. Other security measures, as may be known in the art or may be developed in the future, may be applied to the systems of the present invention.

Administrative tools are provided to manage MC preference settings, user preference settings, PA directory listings, and other system information.

Patient involvement is supported by allowing the patient to register an account that is associated with all of that patient's PAs, with functionality to review and edit (on a moderated basis) their MPI record, to review patient accessible portions of any of their RSs, to complete and submit patient demographic data and new patient information, to access communication and messaging functions, including participation in eVisits when such are supported by the applicable PA, and to participate in other MedTegra communications functionality. For example, in addition to eVisits, a PA and patient or patient proxy can interact via MedTegra to, for example, report on compliance with care instructions. Authorized patient proxies can be notified if a scheduled event does not occur, such as an update report scheduled to be posted daily by the patient.

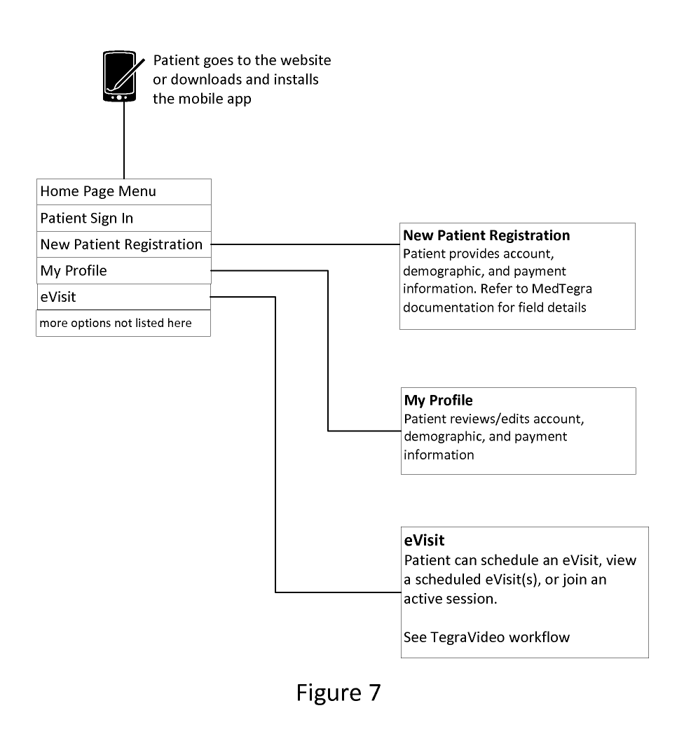

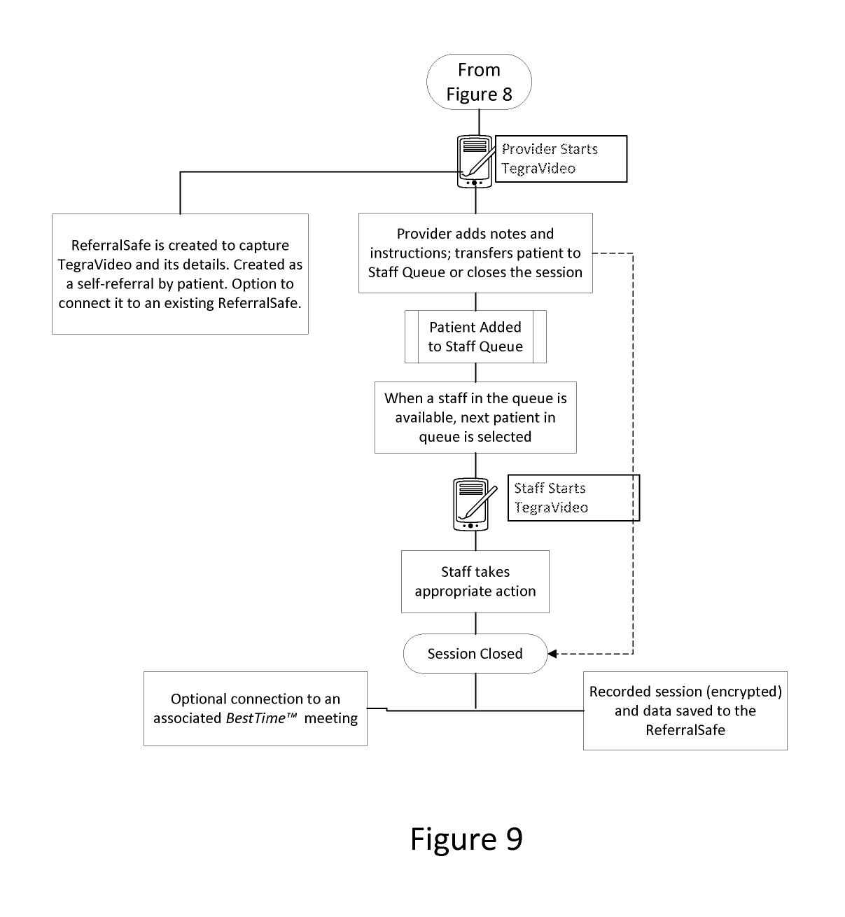

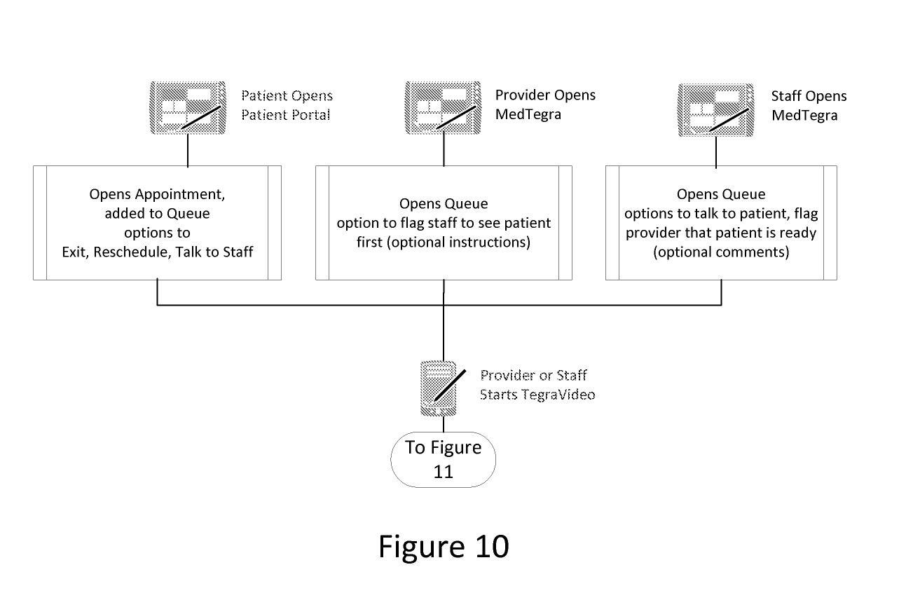

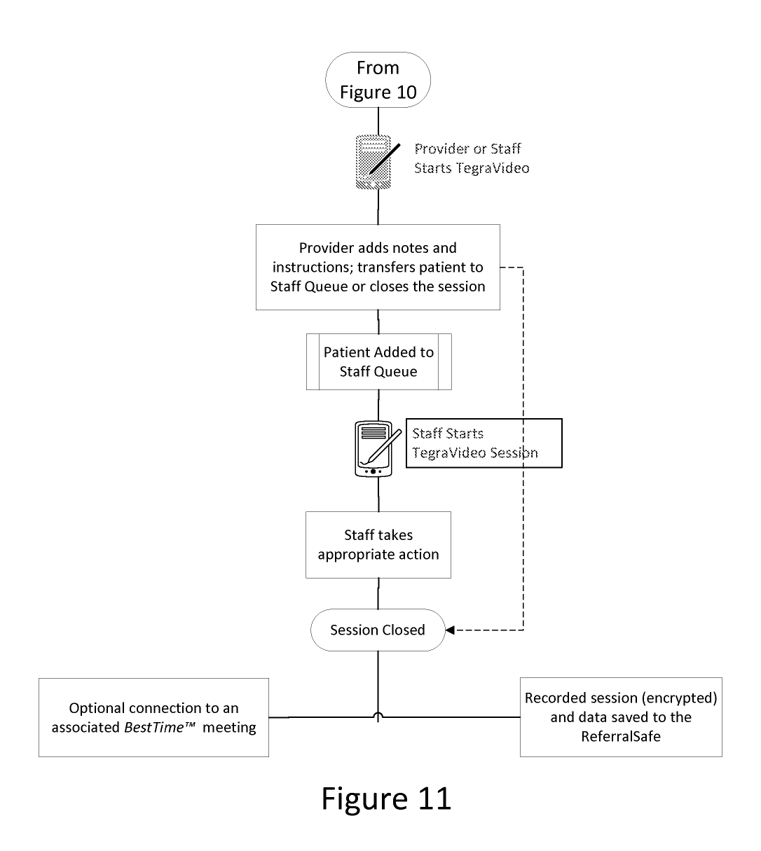

Referring now to FIGS. 7 through 13, the MedTegra system may include, as discussed in the above paragraph, patient connection functionalities as well as video (referred to as TegraVideo) functionalities. The patient may be provided to a patient access portal via a website, mobile application, or the like. FIG. 7 shows exemplary patient access menus and options that may be available through the MedTegra patient connections.

Through patient connections, patients can, for example, create and manage their personal accounts and update their demographic information, including current insurance and payment methods. This information is then accessible to all of the patient's authorized healthcare providers.

Patients can search MedTegra's enhanced provider directory for consistently presented details about selected providers, including specialties, insurances accepted, languages spoken, gender, locations with map and directions, and the like, plus optional biographies and photos off the people and facilities. Each listing can be accessed like, and looks like, an attractive, informative website, for example.

Appointments and appointment changes can be requested, reminders received, and physician instructions reviewed later to refresh the patient's memory. Patients have access to information made available to them by the provider. Authorized family members and other care providers can act on behalf of the patient.

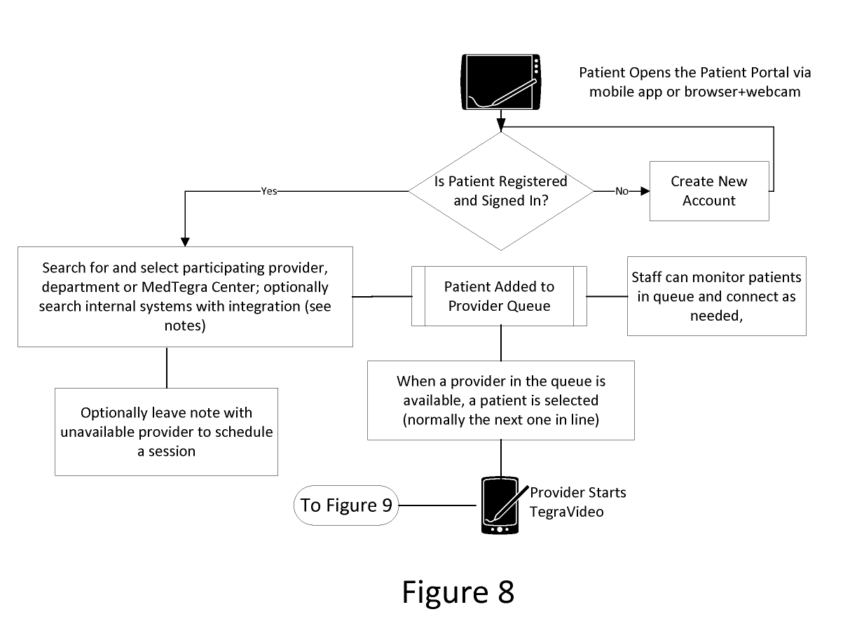

Referring now to FIGS. 8 through 11, patient-initiated sessions can be treated as self-referrals with accompanying MedTegra ReferralSafes, providing all the benefits that come with that. From the provider directory, a patient can see if this service is available from a selected provider and if someone is available to accept a connection now. The patient can make an immediate connection, if available, or schedule or request an appointment (according to settings) for an eVisit with a specific physician or other provider or with a provider who is on call.

The patient connects to the selected office and is placed in a queue. The provider or appropriate staff is informed. The facility can determine whether they want to have physicians and staff on call and whether to allow patients to schedule visits.

Patients in the queue can be triaged before seeing the physician. A patient can be assigned to a specific provider's queue or next available. Staff can gather information from the patient and post pertinent information to the patient's ReferralSafe for the provider. During the visit the provider can post clinical notes, patient instructions, instructions to staff, etc. For convenience, common instructions and notes can be entered using shortcuts or menu selection.

At the end of a session, the provider can either close the session or return the patient to staff for follow-up on instructions provided. If a prescription is ordered or if the patient is sent to another location (ER, office, specialist, etc.), address and telephone information can be pushed to the patient's device with a map and navigation directions. Prescriptions can be communicated to a selected pharmacy. An ER can receive “heads up” information about a patient who has been directed to them. Later, the patient or care provider can return to their online account to view reminders on instructions they were given, post questions, and the like.

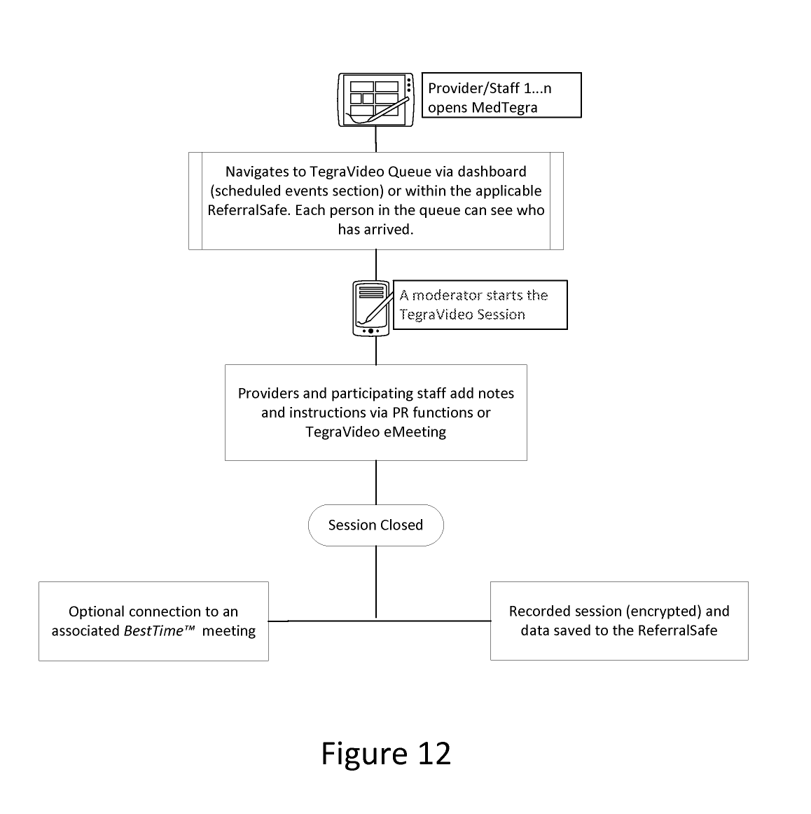

Referring now to FIG. 12, any provider or staff who is authorized access to a ReferralSafe can schedule or instantly open a TegraVideo connection with one or more people in the ReferralSafe. For example, a physician might want to discuss a care incident with a member of her own staff or one or more of the care team physicians could consult about the patient's care among themselves. This capability is further enhanced with MedTegra's meetings.

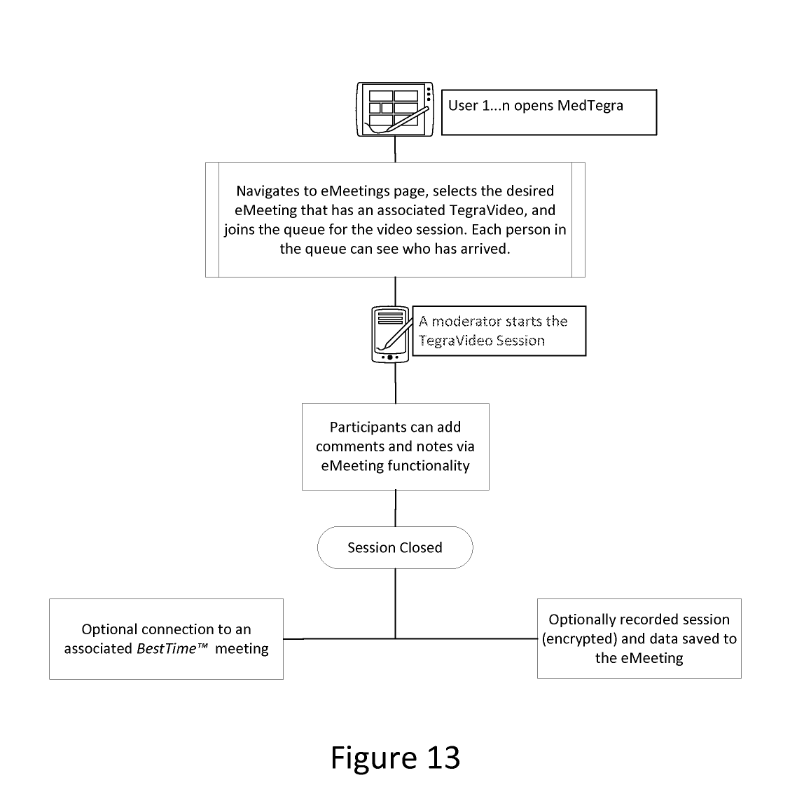

Referring to FIG. 13, TegraVideos may be provided for general use among any group of users. The TegraVideo functionality is not limited to care team members within a ReferralSafe. Rather, functionality is provided to allow any group to communicate with each other when a video conference is indicated. TegraVideo sessions can be used for staff meetings, management meetings, research team discussions, physician consults that are not specific to a particular ReferralSafe, or any desired live connection.

These sessions can be for internal personnel or safely extended to anyone in the MedTegra network and beyond, even when participants are in different MedTegra centers. This functionality provides a very easy and convenient means for conducting video conferences, with or without a MedTegra account.

All of the video functionality can be recorded. When associated with a particular ReferralSafe, the videos may be stored therewithin. The videos may be stored for a given number of years as may be desired by a particular MedTegra center.

MedTegra collaboration functionality can also be used not only within an RS, but by any group of MedTegra users. MedTegra ReferralSafes are not limited to patient referral use, but can also be used as an electronic patient records system within an MC.

The MedTegra functionalities offer a unique approach to seamlessly integrating real-time video conferencing (collaboration) and chat with BestTime™ collaboration (multi-media messaging, file library). The file library is unique in that each eMeeting has its own file library and users can view it from that perspective or a view that spans all the eMeeting file libraries to which they have access. It is done in such a way that a file that is “copied” to more than one eMeeting normally has one copy, so updating it in one place updates it in all eMeetings. One of the many advantages is that users no longer have to guess at which version of a file is the latest as they have to normally plow through a tangled mess of emails, for example. The MedTegra service is also effectively a cloud storage service, making the information available from anywhere at any time.

The system of the present invention may include software written in any one or more programming languages. In some embodiments, the software may be designed to operate on a computer system, having a central processing unit, memory and other typical computer components. In some embodiments, the software may reside on a server and operate on various computers or computer terminals via, for example, the internet. In some embodiments, the software may reside at least partially on a server or cloud-based system or on an internet-based system.

The software of the present invention may include computer code, disposed on a computer readable medium, adapted to perform the various functions as described herewithin.

It should be understood, of course, that the foregoing relates to exemplary embodiments of the invention and that modifications may be made without departing from the spirit and scope of the invention as set forth in the following claims.

What is claimed is:

1. A computer-implemented method, written as a programmable code, stored on a computer readable medium, and adapted to manage referral of patients, the method comprising:
signing into a computer system as a sending provider agent, the computer system having a plurality of provider agents registered therewith;
searching a master patient index database for a patient to be referred;
selecting a receiving provider agent to refer the patient;
electronically sending, through the computer system, information on the patient to be referred;
receiving, by the receiving provider agent, through the computer system, the information on the patient to be referred; and
entering, by the receiving provider agent, a final report concerning the patient, the final report viewable by the sending provider agent.

2. The method of claim 1, further comprising selecting the patient from the master patient index database and confirming that a correctly patient is identified.

3. The method of claim 1, further comprising contacting the receiving provider agent to schedule an initial appointment, set final report due date and assign access level.

4. The method of claim 1, further comprising attaching information and documents to the information on the patient to be referred.

5. The method of claim 1, further comprising sending information to the receiving provider agent and obtaining and posting insurance authorization details.

6. The method of claim 1, further comprising updating, by the receiving provider agent, a patient referral status.

7. The method of claim 1, further comprising reviewing the final report by the sending provider agent and closing the patient referral.

8. The method of claim 1, further comprising setting up a provider database in the computer system by configuring a site as a center using the computer system, entering provider profiles, defining departments, and defining favorites for each provider agent.

9. The method of claim 1, further comprising establishing a computer implemented video connection between a provider agent and an agent.

10. The method of claim 9, wherein the video connection is initiated by one of the provider agent and the agent.

11. A system for managing patient care and referrals comprising:
a computer system including a database of providers and master patient information records;
a referral system application, written as a programmable code, stored on a computer readable medium, and adapted to manage referral of patients, the application comprising code segments to allow users to perform the following steps:
signing into the computer system as a sending provider agent;
searching the master patient index record database for a patient to be referred;
selecting a receiving provider agent to refer the patient;
electronically sending, through the computer system, information on the patient to be referred;
receiving, by the receiving provider agent, through the computer system, the information on the patient to be referred; and
entering, by the receiving provider agent, a final report concerning the patient, the final report viewable by the sending provider agent.

12. The system of claim 11, further comprising code segments to allow users to perform one or more of the following steps:
selecting the patient from the master patient index database and confirming that a correctly patient is identified;
contacting the receiving provider agent to schedule an initial appointment, set final report due date and assign access level;
attaching information and documents to the information on the patient to be referred;
sending information to the receiving provider agent and obtaining and posting insurance authorization details;
updating, by the receiving provider agent, a patient referral status; and
reviewing the final report by the sending provider agent and closing the patient referral.
